(19) United States
(12) Patent Application Publication
(10) Pub. No.: US 2023/0060248 A1
(43) Pub. Date: Mar. 2, 2023

(54) Conveyance Device and Product Vending Machine

(71) Applicant: SANDEN RETAIL SYSTEMS CORPORATION, Isesaki-shi (JP)

(72) Inventors: Takaaki ARAI, Isesaki-shi (JP); Akira MATSUMOTO, Isesaki-shi (JP)

(21) Appl. No.: 17/798,449

(22) PCT Filed: Feb. 1, 2021
(86) PCT No.: PCT/JP2021/003460

§ 371 Date: Aug. 9, 2022

(30) Foreign Application Priority Data
Feb. 10, 2020 (JP) 2020-020486

(51) Int. Cl. G07F 11/58; B65G 35/06; G07F 11/16; G07F 11/42

(52) U.S. Cl. CPC G07F 11/58; B65G 35/06; G07F 11/1653; G07F 11/42; B65G 2201/02

(57) ABSTRACT

A conveyance apparatus includes: a conveyance member including a reception surface configured to receive an article; a movable member connected to a lower surface of the conveyance member; and a driving device configured to move the movable member in one axial direction along a conveyance direction of the conveyance member.

### TECHNICAL FIELD

The present invention relates to a conveyance apparatus and an article vending machine including the conveyance apparatus.

### BACKGROUND ART

As a conveyance apparatus configured to convey articles, there has generally been known a belt conveyor apparatus including an endless conveyance belt wound around a driving pulley and a driven pulley, and a driving device such as a motor configured to drive the driving pulley (see, for example, Patent Literature 1 mentioned below).

### CITATION LIST

### Patent Literature

PTL1: Japanese Patent Application Laid-Open No. 2017-186105

### SUMMARY OF INVENTION

### Technical Problem

In the conventional conveyance apparatus such as a belt conveyor apparatus, the driving device such as a motor to rotate the driving pulley and a mechanism to secure the tension of the conveyance belt are arranged on the side along the width direction of the conveyance belt (the direction orthogonal to the conveyance direction). Therefore, the width of the whole conveyance apparatus including the driving device and the other mechanisms is greater than the width of the conveyance belt. This causes a problem with the installation of the conveyance apparatus that requires a large space in the width direction relative to the width of the conveyance belt.

Meanwhile, there has generally been known an article vending machine configured to receive an article on a reception surface of a bucket from multiple shelves provided in a cabinet by moving the bucket up and down, and move the bucket to convey the received article to an article outlet.

With this article vending machine, when a plurality of articles are bought collectively, the articles are sequentially put on the reception surface of the bucket. This causes a problem with overlapping the articles each other on the reception surface, and a problem with the difficulty of taking the articles from the article outlet because the articles are accumulated in front of the article outlet.

To address the problems, there is an idea that the reception surface of the bucket is used as the conveyance belt of the belt conveyor apparatus, and the positions of the articles are changed every time an article is received. However, as described above, the belt conveyor apparatus needs a large installation space in the width direction relative to the width of the conveyance belt, and therefore, when the conveyance belt is used as the reception surface of the bucket, the size of the bucket is increased. This causes a problem that the article storage space in the article vending machine is pressed by the large bucket.

The present invention has been achieved to solve the above-described problems. It is therefore an object of the invention to provide a conveyance apparatus capable of saving the space to install the conveyance apparatus, and an article vending machine including a bucket moving up and down, which can avoid an increase in the size of the bucket to secure sufficient space to store articles when a mechanism to allow articles to be bought collectively is provided.

### Solution to Problem

To achieve the above-described object, the present invention provides a conveyance apparatus including: a conveyance member including a reception surface configured to receive an article; a movable member connected to a lower surface of the conveyance member; and a driving device configured to move the movable member in one axial direction along a conveyance direction of the conveyance member.

### Advantageous Effect

According to the conveyance apparatus having the above-described feature, the driving device is provided on the lower surface of the conveyance member, and therefore an empty space for installation is not needed outside the conveyance member in the width direction orthogonal to the conveyance direction. Therefore, it is possible to save the space to install the conveyance apparatus.

Moreover, in the article vending machine including the bucket moving up and down, the reception surface of the conveyance member of the conveyance apparatus is employed as the reception surface of the bucket. Therefore, when a mechanism to allow articles to be bought collectively is provided in the article vending machine, it is possible to avoid an increase in the size of the bucket, and therefore to secure sufficient space to store the articles in the article vending machine.

### BRIEF DESCRIPTION OF DRAWINGS

FIG. 1 illustrates the basic configuration of a conveyance apparatus;

FIG. 2 is a rear view illustrating an example of the conveyance apparatus;

FIG. 3 is a front view illustrating an example of the conveyance apparatus;

FIG. 4 is a perspective side view illustrating an example of the conveyance apparatus;

FIG. 5 illustrates an example of the operation of the conveyance apparatus;

FIG. 6 is an external view illustrating an example of an article vending machine;

FIG. 7 illustrates the internal structure of the article vending machine; and

FIG. 8 illustrates a bucket of the article vending machine.

### DESCRIPTION OF EMBODIMENTS

Hereinafter, an embodiment of the present invention will be described with reference to the drawings. The same reference numbers in the different drawings indicate the same functional parts, and therefore repeated description for each of the drawings is omitted.

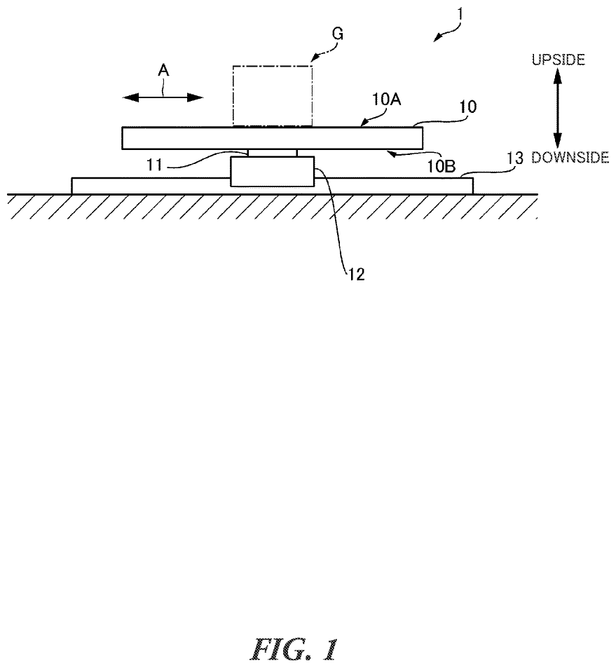

FIG. 1 conceptually illustrates the basic configuration of a conveyance apparatus 1. The conveyance apparatus 1 includes a conveyance member 10 including a reception surface 10A to receive an article G, a movable member 12 connected to a lower surface 10B of the conveyance member 10, and a driving device 13 configured to move the movable member 12 in one axial direction along a conveyance direction A of the conveyance member 10. With the illustrated example, the movable member 12 is connected to the lower surface of the conveyance member 10 via a connection portion 11.

Here, the lower surface 10B of the conveyance member 10 faces downward. The space under the lower surface 10B of the conveyance member 10 is usually a dead space, but the movable member 12 and the driving device 13 are disposed by utilizing the dead space. Here, the driving device 13 is not limited as long as it can move the movable member 12 linearly along the conveyance direction A, and various kinds of linear actuators may be adopted.

According to this conveyance apparatus 1, there is no protrusion of the mechanical components such as the driving device 13 in the width direction of the conveyance member 10 (the plane direction orthogonal to the conveyance direction A). Therefore, it is possible to install the conveyance apparatus 1 as long as there is a space to accommodate the width of the conveyance member 10 in the width direction of the conveyance member 10. By this means, it is possible to save the space to install the conveyance apparatus 1. In addition, the dead space under the lower surface of the conveyance member 10 is utilized to dispose the driving device 13 and so forth. Therefore, when the conveyance apparatus 1 is disposed in various kinds of equipment, it is possible to minimize the occupied space in the equipment. By this means, it is possible to downsize the equipment in which the conveyance apparatus 1 is installed.

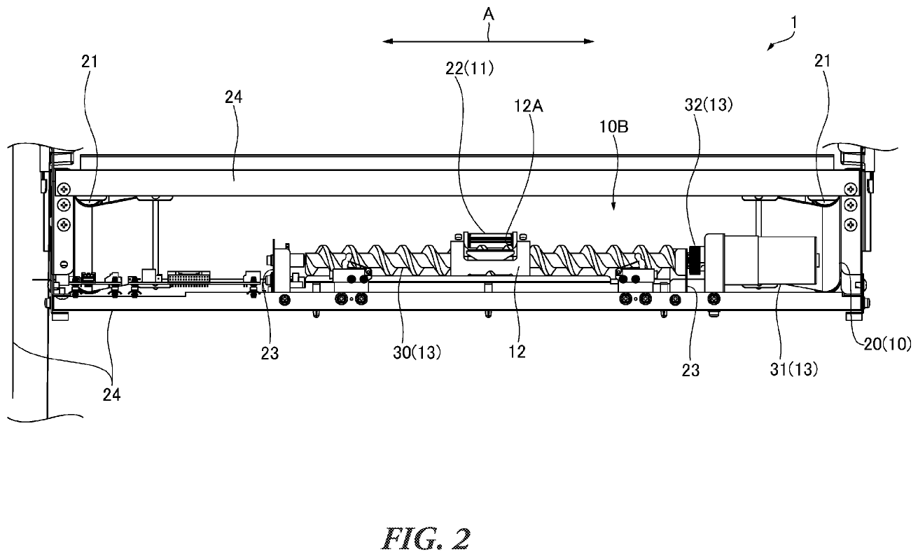

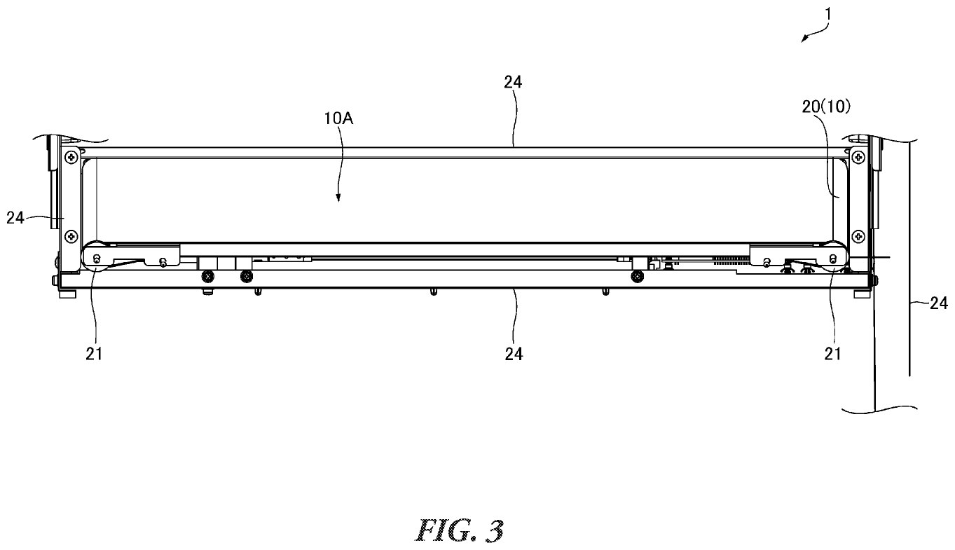

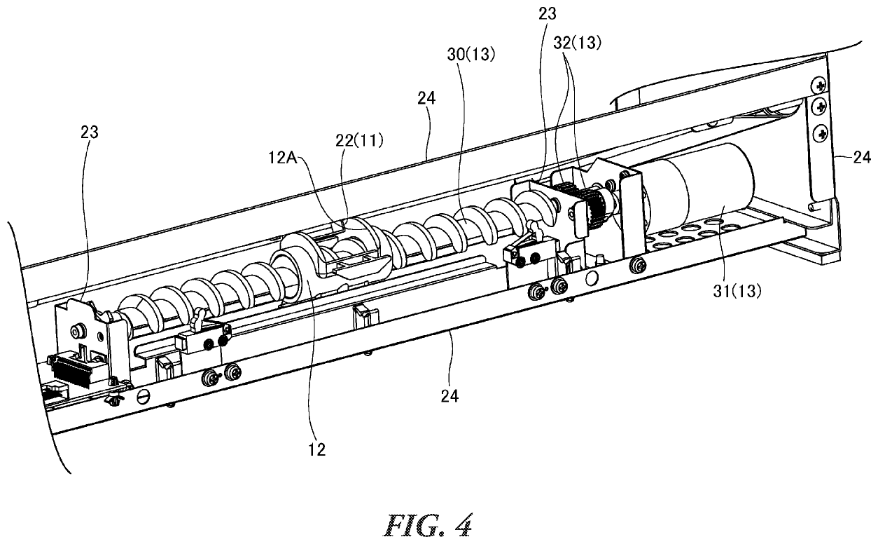

FIG. 2 to FIG. 5 more specifically illustrate configuration examples of the conveyance apparatus 1. The illustrated conveyance apparatus 1 includes a conveyance belt 20 as the conveyance member 10, and a spiral shaft 30, a motor 31, and a train of gears 32 constituting the driving device 13. Here, the movable member 12 is engaged with the spiral shaft 30, and linearly moved by the rotation of the spiral shaft 30 along the spiral shaft 30 extending in the direction the same as the conveyance direction A.

The motor 31 constituting the driving device 13 includes a driving shaft which is coaxial with or parallel to the axial direction of the spiral shaft 30, and rotates the spiral shaft 30 clockwise and counterclockwise. By this means, the movable member 12 engaged with the spiral shaft reciprocates within a set range. The train of gears 32 is provided to increase or decrease the number of rotations of the spiral shaft 30 with respect to the number of rotations of the motor 31. In order to make the number of rotations of the spiral shaft 30 equal to the number of rotations of the driving shaft of the motor 31, the driving shaft of the motor 31 and the spiral shaft 30 may be arranged to be coaxial and connected directly to one another.

The conveyance belt 20 as the conveyance member 10 is an endless belt wound around a pair of pulleys 21. The pair of pulleys 21 is configured to be driven, and is supported by a frame 24 via necessary support members.

A fitted portion 22 corresponding to the connection portion 11 is connected directly to the lower surface 10B of the conveyance belt 20. A fitting portion 12A of the movable member 12 is fitted into the fitted portion 22, so that the lower surface 10B of the conveyance belt 20 and the movable member 12 are connected to one another. The fitting portion 12A is easily fitted into the fitted portion 22 to connect them to one another. After the spiral shaft 30 is installed under the conveyance belt 20 supported by the frame 24 in advance, the movable member 12 and the lower surface 10B of the conveyance belt 20 can be easily connected to one another.

The spiral shaft 30 is rotatably supported by shaft supports 23 at its both ends, and is supported by the frame 24 under the conveyance belt 20. Also, the motor 31 configured to rotate the spiral shaft 30 is supported by the frame 24 under the conveyance belt 20.

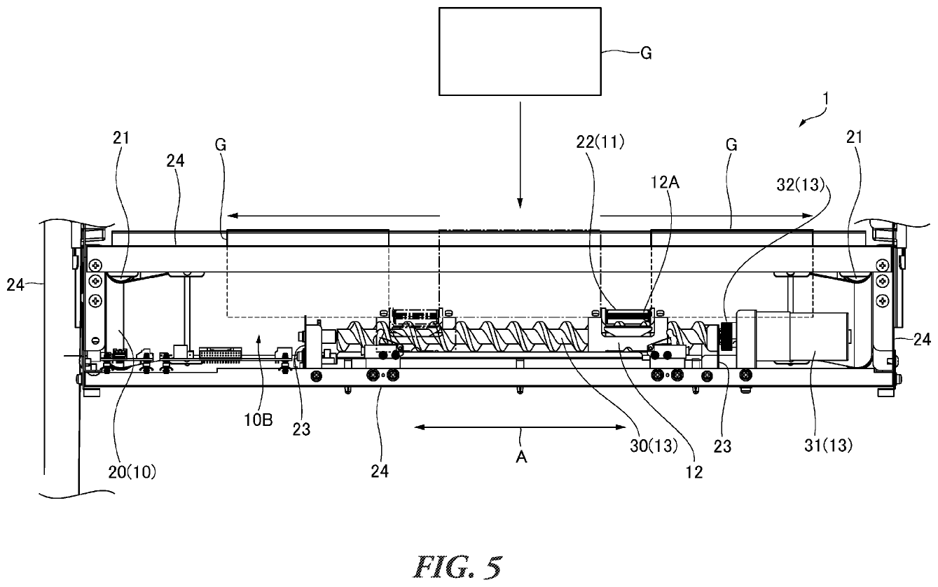

As illustrated in FIG. 5, this conveyance apparatus 1 can reciprocate the movable member 12 along the spiral shaft 30 by rotating the motor 31 clockwise and counterclockwise, and also reciprocate the reception surface 10A of the conveyance belt 20 connected to the movable member 12 on the lower surface 10B side along the conveyance direction A. By this means, after the article G is received on the reception surface 10A, the reception surface 10A is moved, so that it is possible to change the position of the received article G. Accordingly, when a plurality of articles G are sequentially received on the reception surface 10A, it is possible to disperse the receiving positions of the articles G not to overlap each other.

To assemble this conveyance apparatus 1, the components of the driving device 13 are attached on the lower surface 10B side of the conveyance belt 20 installed in the frame 24, and the lower surface 10B can be easily connected to (fitted into) the movable member 12. In this case, the conveyance belt 20 is not driven by driving the pulleys 21, and therefore there is no need to apply tension to the conveyance belt 20. Therefore, it is possible to more easily install the conveyance belt 20.

This conveyance apparatus 1 can be used for various purposes, and in particular, can be suitably used as conveyance means installed in equipment by taking advantage of good space efficiency of the installation.

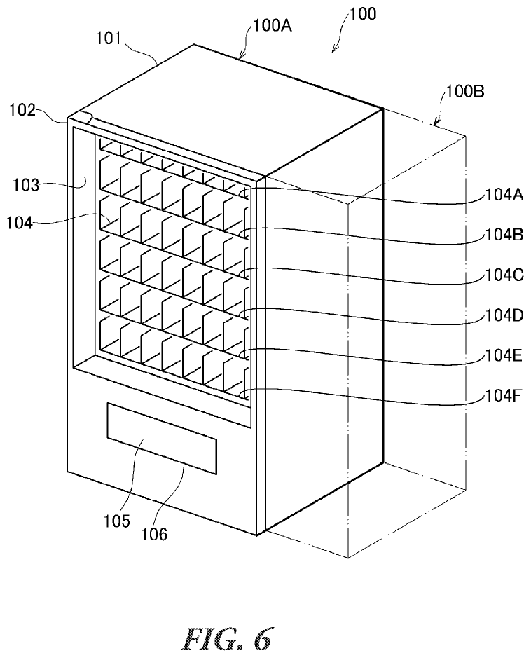

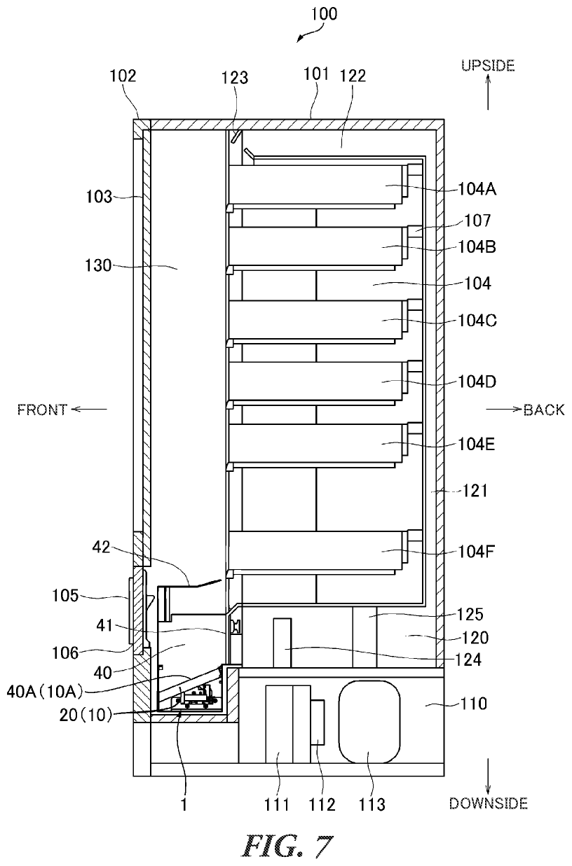

As an example of equipment using the conveyance apparatus 1, an article vending machine will be described. FIG. 6 is an external view schematically illustrating an article vending machine 100. FIG. 7 illustrates the internal structure of the article vending machine 100.

The article vending machine 100 includes a main unit 100A configured to store articles and an operation unit 100B which are arranged side by side. The main unit 100A includes a box cabinet 101 with a door 102 covering a front opening, and an article storage 104 is provided in the cabinet 101.

The operation unit 100B includes an article selection switch, and a charging section configured to receive paper money and coins and pay out change, or settle payment by digital money, which are not illustrated. The settlement of payment is performed by the charging section, and the operation to select an article is performed by the selection switch, so that the operation unit 100B transmits a selling command to the main unit 100A.

The upper part of the front surface of the door 102 of the main unit 100A includes a transparent plate 103 that allows the inside to be visible. An article outlet 106 is provided in the lower part of the door 102, and provided with an outlet shutter 105.

The article storage 104 in the cabinet 101 includes a plurality of shelves 104A to 104F (for example, the number of shelves is six) which are spaced from each other in the up-and-down direction and are open to the front. A plurality of carry-out mechanisms 107 arranged side by side in the right and left direction are provided for each of the shelves 104A to 104F. Each of the carry-out mechanisms 107 may be, for example, a mechanism to rotate a spiral metal bar, and a belt conveyor. Articles stored in the shelves 104A to 104F are arranged for each of the carry-out mechanisms 107 in the front-to-back direction. Any of the carry-out mechanisms 107 is actuated to push the articles to the front side of the shelves 104 to 104F one by one to carry the articles.

There is space to move the bucket 40 (bucket movement space 130) between the front ends of the shelves 104A to 104F and the transparent plate 103 in the front surface of the door 102.

The bucket 40 has a length approximately the same as that of each of the shelves 104A to 104F in the right and left direction, and is disposed to be able to move in the bucket movement space 130 in the up-and-down direction. The bucket 40 is moved in the up-and-down direction by an actuator (not illustrated) provided in the cabinet 101, and can be moved to the position where the back end of the reception surface 40A of the bucket 40 is placed at a level approximately the same as the bottom plate of each of the shelves 104A to 104F. In addition, the bucket 40 can be moved such that a top plate 42 of the bucket 40 is located at a level lower than the bottom surface of the bottom shelf 104F when the bucket 40 reaches the bottom. Here, the position of the bucket 40 reaching the bottom is a standby and take-out position. In this standby and take-out position, the article outlet 106 is located in front of the bucket 40, and the outlet shutter 105 is opened, and therefore it is possible to allow the hand to put in the bucket 40.

A machine room 110 is provided under the article storage 104 in the main unit 100A. A condenser 111, a fan 112, and a compressor 113 are disposed in the machine room 110, and the front and the rear of the machine room 110 communicates with the outside. In addition, a lower duct 120 is provided between the machine room 110 and the bottom shelf 104F, and an evaporator 125 and a fan 124 are provided in the lower duct 120. The rear of the lower duct 120 communicates with a rear duct 121 extending in the up-and down direction behind the article storage 104. Moreover, an upper duct 122 extending in the front-to-back direction is provided above the article storage 104.

The opening in the front part of the upper duct 122 is open to the upper part of the bucket movement space 130. Moreover, a baffle plate 123 inclining forward and downward at, for example, 45 degrees is provided on the upper edge of the opening in the front part of the upper duct 122. Meanwhile, a back panel 41 is provided on the front end of the lower duct 120. The back panel 41 extends in the up-and-down direction to separate between the lower duct 120 and the bucket movement space 130 in front of the lower duct 120.

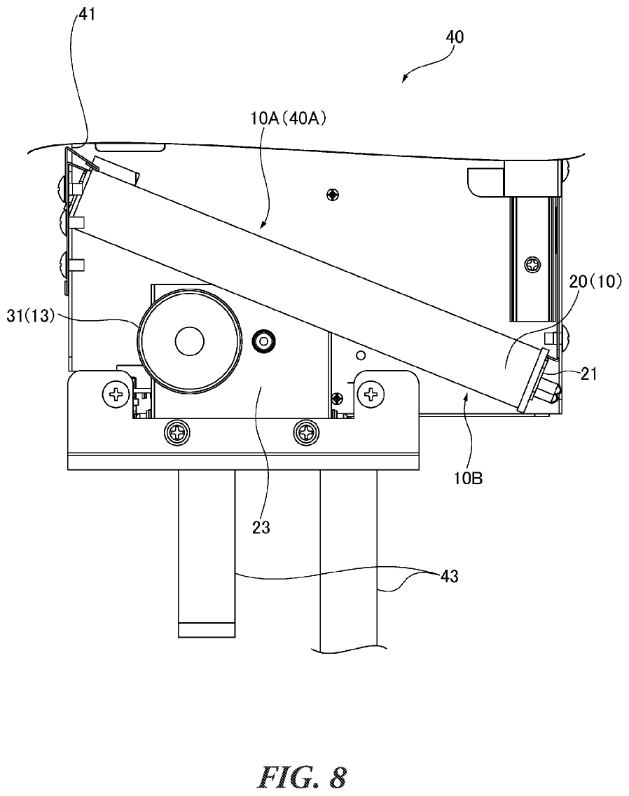

In this article vending machine 100, the reception surface 40A of the bucket 40 is the reception surface 10A of the conveyance apparatus 1. In this case, as illustrated in FIG. 8, the conveyance belt 20 as the conveyance member 10 is provided in the bucket 40 while the conveyance belt 20 is inclined. Then, the upper surface of the conveyance belt 20 serves as the reception surface 40A (10A), and the components such as the motor 31 constituting the driving device 13 are provided under the lower surface 10B. In this case, the components of the driving device 13 can be arranged with good space efficiency, by efficiently utilizing a triangle space under the inclining conveyance belt 20.

The bucket 40 is moved up and down with respect to the shelves 104A to 104F of the article storage 104 as described above, by an actuator (not illustrated) configured to drive an illustrated elevator belt 43.

With this article vending machine 100, when a plurality of articles are bought collectively by one settlement of payment, the bucket 40 is moved up and down to receive the plurality of articles. In this case, it is possible to prevent the articles received by the bucket 40 from overlapping each other by moving the reception surface 10A (40A) of the conveyance belt 20.

Moreover, when the bucket 40 is moved to the bottom to place the reception surface 10A (40A) having the plurality of articles in front of the article outlet 106, the articles are put and dispersed on the reception surface 10A (40A), so that the articles can easily be taken out from the article outlet 106 by opening the outlet shutter 105.

As described above, the embodiments of the present invention have been described in detail with reference to the drawings. However, the specific configuration is not limited to the embodiments, and the design can be changed without departing from the scope of the present invention. In addition, the above-described embodiments can be combined by utilizing each other's technology as long as there is no particular contradiction or problem in the purpose and configuration.

### REFERENCE SIGNS LIST

1: conveyance apparatus,
10: conveyance member, 10A: reception surface,
10B: lower surface,
11: connection portion, 12: movable member
12A: fitting portion, 13: driving device,
20: conveyance belt, 21: pulley, 22: fitted portion,
23: shaft support, 24: frame,
30: spiral shaft, 31: motor, 32: train of gears,
40: bucket, 41: back panel, 42: top plate, 43: elevator belt,
100: article vending machine, 100A: main unit,
100B: operation unit,
101: cabinet, 102: door,
103: transparent plate, 104: article storage,
104A to 104F: shelf
105: outlet shutter, 106: article outlet,
107: conveyance mechanism
110: machine room, 111: condenser
112: fan, 113: compressor,
120: lower duct, 120: rear duct, 122: upper duct,
123: baffle plate, 124: fan, 125: evaporator,
130 bucket movement space, A: conveyance direction,
G: article

1. A conveyance apparatus comprising:
a conveyance member including a reception surface configured to receive an article;
a movable member connected to a lower surface of the conveyance member; and
a driving device configured to move the movable member in one axial direction along a conveyance direction of the conveyance member.

2. The conveyance apparatus according to claim 1, wherein the driving device is configured to reciprocate the movable member within a set range.

3. The conveyance apparatus according to claim 1, wherein:
the conveyance member is an endless conveyance belt wound around a pair of pulleys; and
the movable member includes a fitting portion configured to fit into a fitted portion connected directly to the lower surface of the conveyance belt.

4. The conveyance apparatus according to claim 1, wherein
the driving device includes:
a spiral shaft engaged with the movable member; and
a motor including a driving shaft coaxial with or parallel to an axial direction of the spiral shaft, and configured to rotate the spiral shaft clockwise and counterclockwise.

5. An article vending machine including the conveyance apparatus according to claim 1, the article vending machine comprising:
an article storage including a plurality of shelves configured to store articles, the shelves being arranged in an up-and-down direction; and
a bucket provided to be able to move in the up-and-down direction with respect to the article storage, and configured to receive an article conveyed from the article storage and convey the article to an article outlet,
wherein a reception surface of the bucket to receive the article is a reception surface of the conveyance member.

6. The conveyance apparatus according to claim 3, wherein
the driving device includes:
a spiral shaft engaged with the movable member; and
a motor including a driving shaft coaxial with or parallel to an axial direction of the spiral shaft, and configured to rotate the spiral shaft clockwise and counterclockwise.

7. An article vending machine including the conveyance apparatus according to claim 4, the article vending machine comprising:
an article storage including a plurality of shelves configured to store articles, the shelves being arranged in an up-and-down direction; and
a bucket provided to be able to move in the up-and-down direction with respect to the article storage, and configured to receive an article conveyed from the article storage and convey the article to an article outlet,
wherein a reception surface of the bucket to receive the article is a reception surface of the conveyance member.
